(19) United States
(12) Patent Application Publication
(10) Pub. No.: US 2006/0082880 A1
(43) Pub. Date: Apr. 20, 2006

(54) Device for recording and device for reproducing three-dimensional items of image information of an object

(76) Inventor: Vitalij Lissotschenko, Frondenberg (DE)

Correspondence Address: Hoffman Wasson & Gitler, 2461 South Clark Street, Suite 522 Crystal Center 2, Arlington, VA, 22202, US

(21) Appl. No.: 10/538,729

(22) PCT Filed: Dec. 11, 2003
(86) PCT No.: PCT/EP03/14093

§ 371 Date: Jun. 13, 2005

(30) Foreign Application Priority Data
Dec. 13, 2002 (DE) 102 58 215.7
Jan. 7, 2003 (DE) 103 00 120.4

(51) Int. Cl. G02B 27/22

(52) U.S. Cl. 359/463

(57) ABSTRACT

The invention relates to a device for recording three-dimensional items of image information of an object, including sensing means for sensing light coming from the object and lens means having a number of cylindrical lenses that form lens elements via which light coming from the object can be projected onto the sensing means. At least one first lens element enables the generation of an image of the object or of portions of the object, which are to be recorded, at a first location on the sensing means. This image differs from an image of the object or of the portions of the object, which are to be recorded, that can be generated by at least one second lens element at a second location that is different from the first. The curvature of the cylindrical lenses is greater or less in the edge areas of the lens means than in a middle area of the lens means. Corresponding lens means can also be used for reproducing the three-dimensional items of image information.

### BACKGROUND OF THE INVENTION

This invention relates to a device for recording of three-dimensional image data of an object. This invention relates to a device for reproduction of three-dimensional image data of an object. Furthermore, this invention relates to a process for recording and reproduction of three-dimensional image data of an object. In addition, this invention relates to a microscope, a video device and a photo device for recording and reproduction of three-dimensional image data of an object.

A device for recording and a device for reproduction of three-dimensional image data of an object, a process for recording and reproduction of three-dimensional image data and a photo means for recording and reproduction of three-dimensional image data are known from Lippmann G., J. de phys. theor. et appl., 1908, vol. 7, pp. 821-825. The photo device described in this literature citation is also known as an integral photography device. In the device described therein, the light emerging from an object is imaged by a lens array with a plurality of lens elements onto a photographic plate. The lens elements are for example arranged comparatively tightly next to one another on a square surface so that the light emerging from the object passes through each of the lens elements at a somewhat different angle. Somewhat different images of the object are formed on the photographic plate behind each of the lens elements. The photographic plate can be developed so that a photo can be made. In front of this photo according to the aforementioned art exactly the same array of lens elements can be positioned such that the individual images of the object can be merged again into an overall picture of the object for the viewer by the array of lens elements. This picture is a three-dimensional picture.

A device for recording and a device for reproduction of three-dimensional image data, a process for recording and reproduction of three-dimensional image data and a photo means for recording and reproduction of three-dimensional image data of the initially mentioned type are known from U.S. Pat. No. 2,174,003, in which arrays of cylinder lenses, which arrays are crossed to one another, form lens elements for the imaging of the object onto recording means. Integral photographs can also be produced using these lens elements. The disadvantage in this device is on the one hand the comparatively poor imaging of the partial beams which have passed through the edge areas of the lens means and on the other hand the low contrast between the partial beams of light which have passed through the different lens elements.

U.S. Pat. No. 3,852,524 and U.S. Pat. No. 3,878,329 further develop the original devices of Lippmann such that photomultipliers are used as the recording means and cathode ray tubes are used as the reproduction means. In international patent application WO 94/09390 CCD chips are proposed as the recording means and liquid crystal displays are proposed as the reproduction means.

In European patent application EP 0 520 179 A1 it is suggested that three-dimensional image data be digitally prepared, especially improved by interpolation with respect to resolution. Then these image data are printed out such that they can be viewed using the corresponding lens means as a three-dimensional picture.

It is an object of this invention is to devise a device for recording and a device for reproduction of image data of the initially mentioned type, which are built to be more efficient. Furthermore, a process for recording and reproduction of image data of the initially mentioned type which can be more efficiently carried out will be given. Furthermore, a microscope, a video device and a photo device for recording and reproduction of image data of the initially mentioned type which are built to be efficient will be devised.

### SUMMARY OF THE INVENTION

This is accomplished with respect to a device for recording of three-dimensional image data by the features of claims 1 and 2, with respect to the device for reproduction of three-dimensional image data.

It is provided that the curvature of the cylinder lenses is made greater or lesser in the edge areas of the lens means than in the middle area of the lens means. Especially with greater execution of the curvature of the cylinder lenses in the edge areas the partial beams which are incident at a comparatively large angle in the edge area and which proceed from the object which is to be recorded can be imaged more easily and completely onto the recording means.

It is further provided that between the individual cylinder lenses grooves are formed which extend parallel to the cylinder axes of the cylinder lenses. These grooves can increase the contrast between the light which has passed through different lens elements.

It is possible for the cylinder lenses to have a spherical and/or an aspherical curvature. In particular imaging errors can be avoided by cylinder lenses with at least partially aspherical curvature.

It can be provided that the lens means have a first array of cylinder lenses and a second array of cylinder lenses, the cylinder lenses of the first array being aligned essentially perpendicular to the cylinder lenses of the second array. These arrays of cylinder lenses which are crossed to one another can be easily produced on the one hand and on the other can be used with great effectiveness as arrays of imaging elements.

Here it is possible for the first array of cylinder lenses to be made on one entry surface of lens means which can be turned toward the object and for the second array of cylinder lenses to be made an one exit surface of the lens means which can be turned away from the object. For example, here the entry surface and the exit surface can be made on a glass substrate or the like. But it is also possible for two or more glass substrates or the like to be arranged behind one another, on the entry surface of one of the glass substrates or the like there being an array of cylinder lenses and on the exit surface of another of the glass substrates or the like an array of cylinder lenses which is crossed to the first is made.

Here it is possible for each of the lens elements to be formed by one cylinder lens on the entry surface and for one cylinder lens to be formed on the exit surface. This configuration makes it possible to comparatively easily build the lens elements.

It can be provided that the distance between the recording means and the lens means corresponds roughly to the focal length of the lens elements. In this way the imaging is good for an object which is comparatively far away from the lens means.

In particular, the distance between the recording means and lens means can be variable. Depending on the distance of the object from the lens means, by changing the distance between the lens means and the recording means it is possible to influence the imaging of the object on the recording means.

For example, the recording means can comprise one part of a printing device on which changes can be achieved by incident image data such that controlled toner application is enabled according to the image data. Here for example it is possible for a printing roller or the like to be selectively changed by the light which has passed through the lens means by the image data such that a printout which is made according to the image data can be produced.

According to one alternative embodiment of the recording means, it can be provided that they comprise at least one sensor element which can be read out digitally and/or electronically, especially at least one CCD chip or an array of CCD chips. By one such CCD which is used as a sensor element the image data of the light which has passed through the imaging means can be easily recorded and output or further processed. Here it can be provided that at least one CCD chip or each of the CCD chips can record the light which has been imaged by the imaging element or the light which has been imaged by a group of imaging elements. For example, in a CCD chip per imaging element the light which has passed through this imaging element could be recorded with a comparatively large number of pixels and thus with high resolution. But it is also quite possible to provide larger CCD chips which record the light which has passed through several imaging elements. In the extreme case it can even be imagined that there is a single large CCD chip which records all the light which has passed through the imaging means.

Advantageously the recording means can record the light which has been imaged by one of the lens elements separately from the light which is imaged by the other of the lens elements. In this way the image data which correspond to the light which has passed through one of the lens elements can be recorded and processed separately from the image data which correspond to the light which has passed through the other of the lens elements.

It is possible for the device to comprise read-out means and/or processing means which can process and/or read out the image data of the object which has been recorded by the recording means.

It is furthermore possible for the three-dimensional image data to be data about static images for example in the form of photo data or to be image data about moving images for example in the form of video data.

It is provided that the device for reproduction of three-dimensional image data of an object is characterized in that the reproduction means can reproduce image data which have been recorded with a device for recording of three-dimensional image data. Moreover, with the device as claimed in the invention for reproduction of three-dimensional image data the aforementioned three-dimensional photos or the aforementioned three-dimensional videos can be reproduced.

In particular, in the device for reproduction of image data the lens means can be made like the lens means of the device for recording of image data. Thus, for example, also the lens means used within the framework of recording of image data can be located in front of the reproduction means in order to enable three-dimensional reproduction of the recorded image data. If thus the lens means are made as two cylinder lens arrays which are crossed to one another, these arrays of crossed cylinder lenses can also be located in front of the reproduction means in order to enable viewing of a three-dimensional photo or three-dimensional video.

Furthermore, it is possible for the lens means to correspond to the lens means of the device for recording of image data, but to be made smaller or larger compared to it. In this way it is possible to also assign correspondingly enlarged lens means to enlarging reproduction means so that by comparatively simple measures a for example enlarged three-dimensional image of the object can be produced.

The reproduction means can be made as a passive reproduction means, especially as a printout or the like. A printout certainly constitutes a very easily implemented form of the reproduction means. In particular a printout can also be easily scaled, for example doubled or tripled in its size. Only accordingly enlarged or reduced imaging means need be selected according to the size of the printout.

According to another preferred embodiment of this invention, the reproduction means are made as active reproduction means, especially as a screen or display in the form of a cathode ray screen or liquid crystal display or as an optical image output device, for example as a beamer or laser television or the like. It is thus for example possible to position lens means which are made as an array of crossed cylinder lenses in front of a liquid crystal display so that the image data of the recorded object can be output three-dimensionally by such an arrangement.

The device for reproduction can be made such that the image data are data about static images, for example in the form of photo data, or data about moving images, for example in the form of video data. Therefore it is also possible to provide a liquid crystal display with a corresponding lens means so that the viewer can watch three-dimensional videos.

The process calls for three-dimensional image data of an object to be recorded by means of a device for recording of three-dimensional image data and for the recorded three-dimensional image data to be reproduced by means of the device for reproduction of three-dimensional image data.

Advantageously, after recording and before reproduction of image data, they can be processed, especially digitally processed. The existing art discloses the problem that photos prepared with integral photography often show two three-dimensional images, specifically one in front of and one behind the reproduction means. This can be prevented by digital image processing so that the viewer perceives only one image behind the reproduction means, for example behind the surface of the liquid crystal display.

The microscope is characterized in that the image data can be recorded with a device for recording of three-dimensional image data and can be reproduced with a device for reproduction of three-dimensional image data. Observation of biological objects three-dimensionally with the microscope is an especially good idea here. Here for example the viewer could view three-dimensionally the object to be studied on reproduction means which are made as a liquid crystal display and on which the corresponding lens means are located. An object which is viewed three-dimensionally in this way can be much more easily manipulated than an object viewed two-dimensionally.

The video device is characterized in that the image data can be recorded with a device for recording of three-dimensional image data and can be reproduced with a device for reproduction of three-dimensional image data.

The photo device is characterized in that the image data can be recorded with the device for recording of three-dimensional image data and can be reproduced with a device for reproduction of three-dimensional image data.

### BRIEF DESCRIPTION OF THE DRAWINGS

Other features and advantages of this invention are illustrated using the following description of preferred embodiments with reference to the attached figures.

FIG. 1a shows a side view of the device for recording of image data of an object;

FIG. 1b shows a view according to the arrow I b in FIG. 1a;

FIG. 2 shows a view according to the arrow II in FIG. 1a;

FIG. 3 shows a view according to the arrow III in FIG. 1a;

FIG. 4a shows a side view of the device as claimed in the invention for reproduction of image data of an object;

FIG. 4b shows a view according to the arrow IV b in FIG. 4a;

FIG. 5a shows a side view of lens means of the device for recording or for reproduction of image data;

FIG. 5b shows a side view of the lens means as shown in FIG. 5a, turned by 90° ;

FIG. 6a shows a side view of lens means of another embodiment of a device for recording or for reproduction of image data; and

FIG. 6b shows a side view of the device as shown in FIG. 6a, turned by 90° .

### DETAILED DESCRIPTION OF THE INVENTION

In the aforementioned figures, for better orientation, axes of a Cartesian coordinate system are drawn.

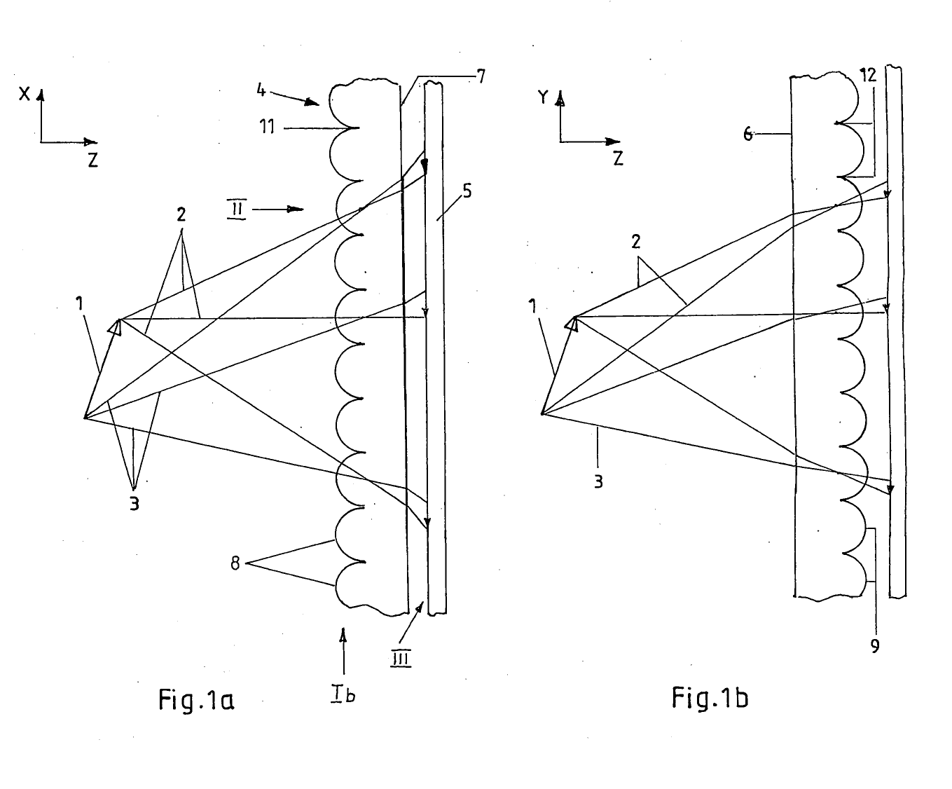

FIG. 1 and FIG. 1b show an object 1 which is shown schematically as an arrow. The object 1 can be a self-illuminating object or an object which is illuminated by external light sources. Of the light proceeding from the object, FIG. 1a and FIG. 1b show individual partial beams 2, 3 which proceed from different ends of the object 1.

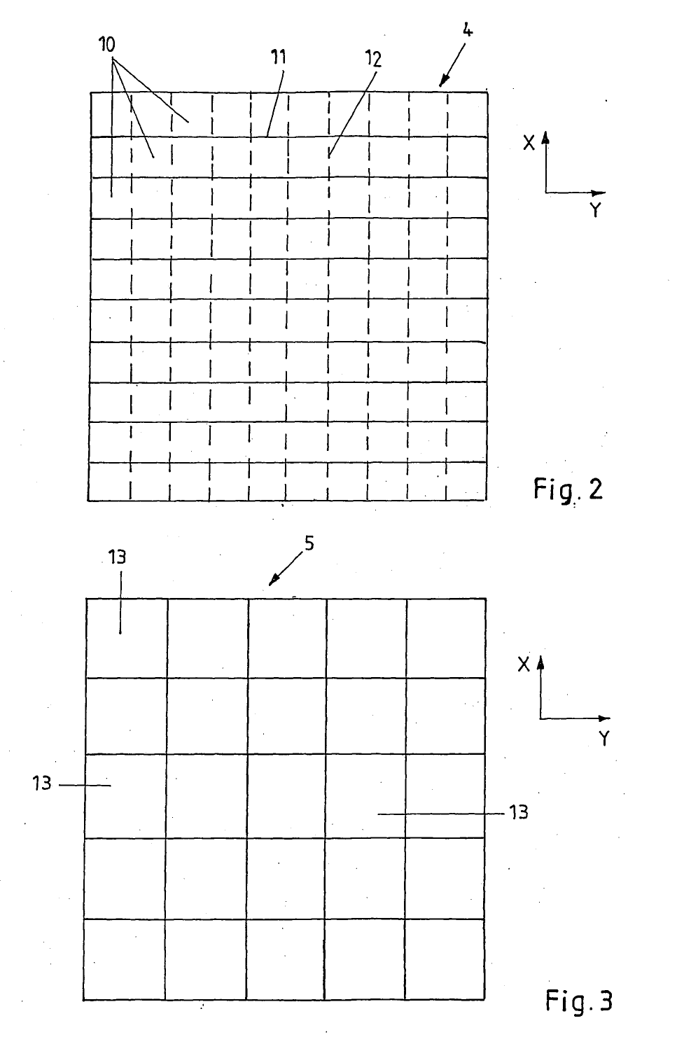

The device for recording of image data of an object comprises lens means 4 and recording means 5 which are used as imaging means. The lens means 4 on their entry surface 6 and also on their exit surface 7, i.e. both on their side facing the object 1 and also on their side facing away from the object, have an array of especially convex cylinder lenses 8, 9. Here the cylinder lenses 8 on the entry surface 6 have one cylinder axis in the X direction and the cylinder lenses 9 on the exit surface 7 have one cylinder axis in the X direction. The cylinder lenses 8, 9 are thus arranged perpendicular to one another and constitute crossed cylinder lenses 8, 9. In this way, by combining the entry surface 6 and the exit surface 7, a plurality of lens elements 10 is formed which are used as imaging elements which each comprise one cylinder lens portion on the entry surface 6 and one cylinder lens portion on the exit surface 7. These lens elements 10 are clearly apparent from the front view of the entry surface as shown in FIG. 2.

The lens means 4 can be imaged both in the X and also in the Y direction more extended than shown in FIG. 1a, FIG. 1b, and FIG. 2, especially the lens means 4 can comprise many more lens elements 10 than shown.

Grooves 11 are formed between the cylinder lenses 8 on the entry surface 6. Grooves 12 are formed between the cylinder lenses 9 on the exit surface 7. Partial beams from an object 1 which are incident on these grooves 11, 12 either do not pass in the direction to the recording means 5 through the lens means 4 or are deflected uncontrolled such that they cannot be picked up by the recording means 5 or cannot be selectively picked up. The grooves 11, 12 thus increase the contrast between light which has passed through different lens elements 10.

The cylinder lenses 8, 9 can have a spherical curvature. But it is also quite possible for the cylinder lenses 8, 9 to be made as cylinder lens-like lenses with an aspherical curvature. Here for example a parabolic, elliptical, hyperbolic, sinusoidal or polynomial curvature of higher order can be chosen.

It is possible for the cylinder lenses 8, 9 which are located in the edge areas of the entry surface 6 or the exit surface 7 to have a greater or lesser curvature than the cylinder lenses 8, 9 in the central or middle area of the entry surface 6 or the exit surface 7. This can result in that the beams which are passing through the lens elements 10 of the lens means 4, which elements are located farther outside, are selectively deflected more strongly or more weakly. It is furthermore possible for the distance of the recording means 5 from the lens means 4 to be changed in order to thus take into account the distance of the object 1 from the lens means 4. In particular, when the distance of the recording means 5 to the lens means 4 corresponds roughly to the focal length of the individual lens elements 10, more or less good imaging of the object 1 onto the recording means 5 by the lens means 4 can be ensured.

It is possible for the image of the object 1 or the parts of the object 1 which are to be recorded onto the recording means 5 to differ by any of the lens elements 10 from any one of the images of the object 1 by the other lens elements 10, in particular any one of the images being produced by different lens elements 10 at different locations on the recording means 5. Such a measure downstream of any one of the lens elements 10 at the points or areas assigned to them on the recording means 5 yields a somewhat different image of the object 1 or of the parts of the object 1 which are to be recorded, which image differs especially by the recording angle. In this way generation of a three-dimensional image from many different individual images is enabled.

The recording means 5 can be made for example as an array of CCD chips 13, as is indicated schematically in FIG. 3. Here for example it is possible for several lens elements 10, especially for example 20 to 70, especially 48, to be assigned to one CCD chip 13. Alternatively, it is possible to assign more than the aforementioned number of lens elements 10 to one CCD chip 13. For example, all the recording means 5 could also consist of a single large CCD chip. Alternatively it would also be possible to assign each of the lens elements 10 to a CCD chip 13 or even to assign more than one CCD chip 13 to each of the lens elements 10.

But it is also quite possible, instead of a CCD chip 13 or an array of CCD chips 13, to provide recording means 5 which are made differently. Here it could be recording means which can detect light and which can store the image data contained in this light and/or can relay them to an evaluation unit. Other possibilities for recording means are parts of a printing device such as for example a printing roller or the like on which the image data which correspond to the object 1 trigger changes such that selective toner application can take place according to the image data.

The device for recording of image data can furthermore comprise readout means for reading out data from the recording means. In particular, these readout means can be coupled to processing means. Here a computer can be used into which the image data can be read from the recording means 5 which is made for example as an array of CCD chips 13. These data can accordingly be processed digitally.

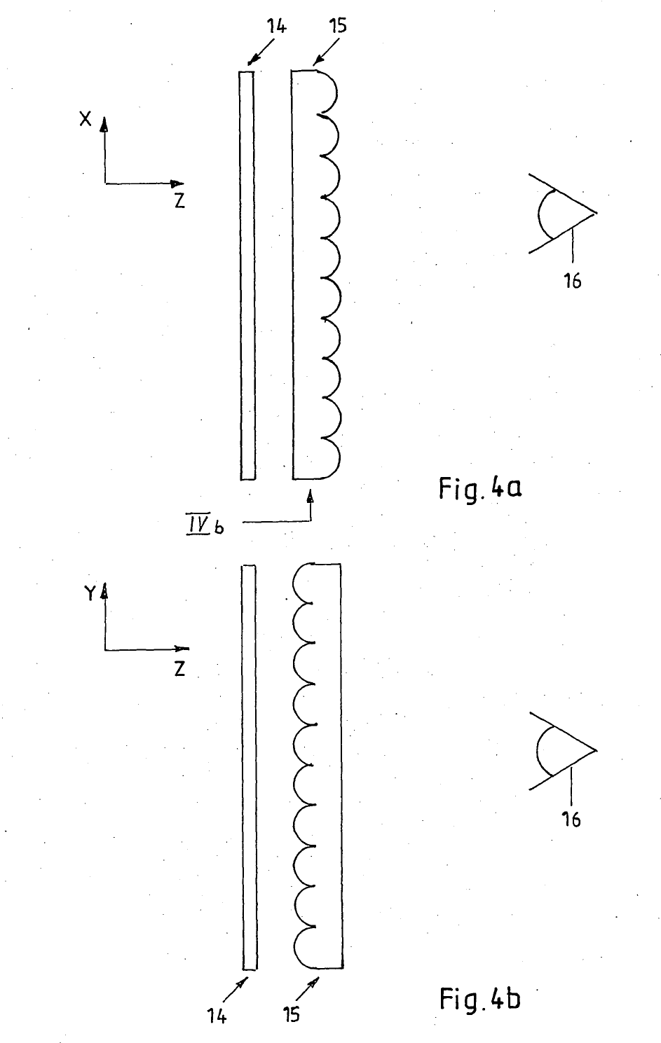

The device shown in FIG. 4a and FIG. 4b for reproduction of image data comprises essentially reproduction means 14 and lens means 15 which are used as the imaging means and which are located between the reproduction means 14 and the schematically shown eye 16 of the viewer. In this way it is ensured that the light emerging from the reproduction means 14 is incident through the lens means 15 on the eye 16 of the viewer. In particular, the lens means 15 can correspond exactly to the lens means 4. But it is also possible for the lens means 15 to be larger or smaller than the lens means 4 by a definable factor, depending on whether the reproduction means 14 reproduce the image data recorded by the recording means 5 with the same size, larger, or smaller. A detailed picture of the lens means 15 according to FIG. 2 is omitted here, because especially when the lens means 4 and the lens means 15 are the same size they are also made exactly the same according to one preferred embodiment of this invention.

A printout of the image data can be used as the reproduction means 14, for example. This printout would then have to be suitably illuminated in order to enable the viewer to see the image. Instead of a printout, a display screen, for example a liquid crystal display, could also be used as the reproduction means 14. Under certain circumstances here the lens means 15 could be applied directly to the liquid crystal display.

Furthermore, it is possible to use the light exit surfaces of optical image output devices such as for example beamers or laser television or the like as reproduction means 14.

A three-dimensional image of the object 1 is made available to the viewer by the devices for recording and reproduction of image data. The object 1 can be a static object from which a three-dimensional photo is produced. But it is also quite possible for the object 1 to be a moving object so that moving images of the object are recorded. In this way the device as claimed in the invention for recording and reproduction of image data can output three-dimensional images.

In particular it is possible, after recording and before reproduction of the image data, to process then digitally such that the viewer sees the object in any case as located behind the lens 15. In the prior art which is known as integral photography there is the problem that under certain circumstances two images are formed, specifically one in front of the lens means and one behind the lens means. This can be avoided by the corresponding digital image processing.

Another application of this invention is in three-dimensional microscopy, where especially a biological object can be observed three-dimensionally and in this way can be better altered. Here a device as claimed in the invention for recording and reproduction of image data could be part of a microscope, the viewer being able to look three-dimensionally at the object which is to be studied for example on a reproduction means which is made as a LCD display on which the corresponding lens means are located. Specifically manipulations with extremely small tools can of course be done much more easily on an object which is viewed three-dimensionally in this way.

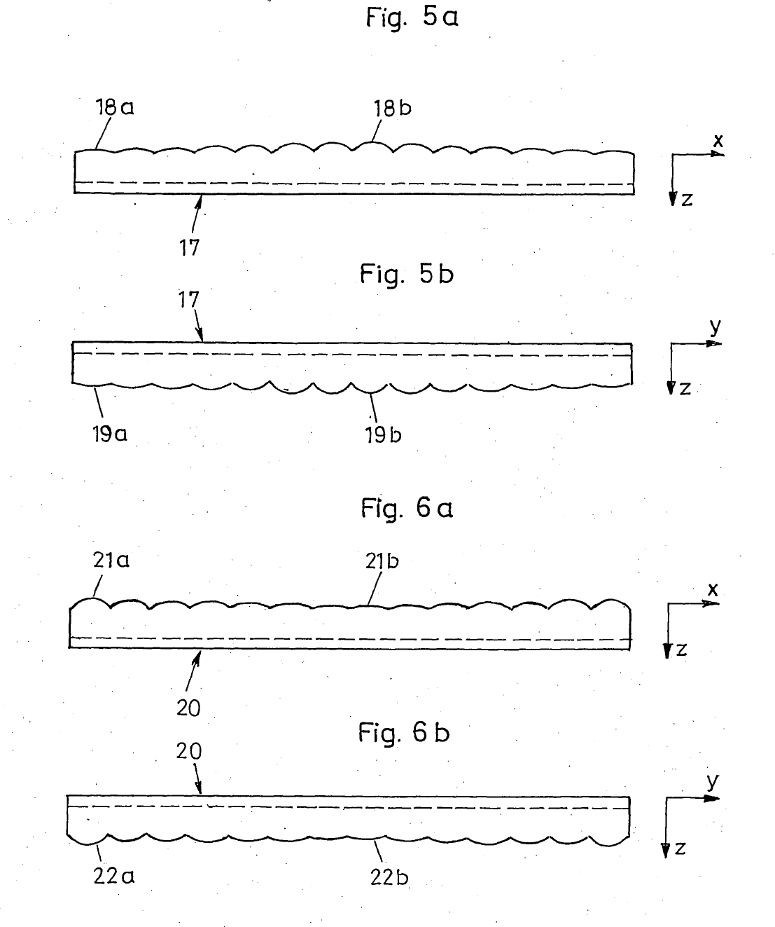

FIGS. 5a and 5b show lens means 17 which on their entry surface have cylinder lenses 18a, 18b and on their exit surface have cylinder lenses 19a, 19b. The cylinder axes of the cylinder lenses 18a, 18b on the entry side are perpendicular to the cylinder axes of the cylinder lenses 19a, 19b on the exit side. FIG. 5a and FIG. 5b show in particular that the cylinder lenses 18a, 18b in the edge areas of the lens means 17 have a weaker curvature than the cylinder lenses 18b, 19b in the center of the lens means 17.

FIG. 6a and FIG. 6b show lens means 20 with cylinder lenses 21a, 21b; 22a, 22b which are aligned perpendicular to one another on the entry and exit surface according to FIG. 5a and FIG. 5b. In contrast to the embodiment as shown in FIGS. 5a and 5b, however the cylinder lenses 21a, 22a in the edge areas of the lens means 20 have a greater curvature than the cylinder lenses 21b, 22b in the middle of the lens means 20.

### REFERENCE NUMBER LIST

1 object
2, 3 partial beams of light from the object
4, 17, 20 lens means
5 recording means
6 entry surface
7 exit surface
8, 9 cylinder lenses
10 lens elements
11, 12 grooves
13 CCD chip
14 reproduction means
15 lens means
16 eye of the viewer
18a, 18b, 19a, 19b cylinder lenses
21a, 21b, 22a, 22b cylinder lenses

What is claimed is:

1. A device for recording of three-dimensional image data of an object, comprising the following:
recording means for recording of a light emerging from the object; and
lens means with a plurality of cylinder lenses which form lens elements through which the light emerging from the object can be imaged onto a recording means, by at least the first of the lens elements an image of the object or of parts of the object which are to be recorded being able to be produced at a first location on the recording means, this image differing from the image of the object or of parts of the object which are to be recorded, which can be produced by at least the second of the lens elements at a second location which is different from the first,
wherein a curvature of the cylinder lenses in the edge areas of the lens means is made greater or lesser than in a middle area of the lens means.

2. The device for recording of image data as claimed in claim 1, wherein between the individual cylinder lenses, grooves are made which extend parallel to the cylinder axes of the cylinder lenses.

3. The device for recording of image data as claimed in claim 1, wherein the cylinder lenses have a spherical and/or an aspherical curvature.

4. The device for recording of image data as claimed in claim 1, wherein the lens means have a first array of cylinder lenses and a second array of cylinder lenses, the cylinder lenses of the first array being aligned essentially perpendicular to the cylinder lenses of the second array.

5. The device for recording of image data as claimed in claim 4, wherein the first array of cylinder lenses (8, 18a, 18b, 21a, 21b) is made on an entry surface of the lens means which can be turned toward the object, and wherein the second array of cylinder lenses is made on an exit surface of the lens means which can be turned away from the object.

6. The device for recording of image data as claimed in claim 5, wherein each and every one of the lens elements is formed by a cylinder lens on the entry surface and a cylinder lens on the exit surface.

7. The device for recording of image data as claimed in claim 1, wherein the distance between the recording means and the lens means corresponds roughly to the focal length of the lens elements.

8. The device for recording of image data as claimed in claim 1, wherein the distance between the recording means and the lens means can be changed.

9. The device for recording of image data as claimed in claim 1, wherein the recording means comprise a part of a printing device on which changes can be achieved by the incident image data such that selective toner application is enabled according to the image data.

10. The device for recording of image data as claimed in claim 1, wherein the recording means comprise at least one sensor element which can be read out digitally and/or electronically, by at least one CCD chip or an array of CCD chips.

11. The device for recording of image data as claimed in claim 1, wherein the recording means can record the light which has been imaged by one of the imaging elements separately from the light which is imaged by the other of the imaging elements.

12. The device for recording of image data as claimed in claim 1, wherein the device comprises read-out means and/or processing means which can process and/or read out the image data of the object which have been recorded by the recording means.

13. The device for recording of image data as claimed in claim 1, wherein the three-dimensional image data are data about static images for in the form of photo data or are image data about moving images, in the form of video data.

14. The device for reproduction of three-dimensional image data of an object as claimed in claim 1, further comprising the following:
reproduction means for reproducing image data of the object; and
lens means with a plurality of lens elements which can image the light proceeding from the reproduction means,
wherein the reproduction means can reproduce the image data which have been recorded with a device for recording of image data.

15. (canceled)

16. (canceled)

17. The device for reproduction of image data as claimed in claim 14, wherein the reproduction means are made as passive reproduction means, as a printout.

18. The device for reproduction of image data as claimed in claim 14, wherein the reproduction means are made as active reproduction means, as a screen or display in the form of a cathode ray screen or liquid crystal display or as an optical image output device, as a beamer or laser television.

19. The device for reproduction of image data as claimed in claim 14, wherein the image data are data about static images, in the form of photo data, or are data about moving images, in the form of video data.

20. A process for recording and reproduction of three-dimensional image data of an object, comprising the following process steps:
image data of an object are recorded by means of a device as claimed in claim 1 for recording of image data ; and
the recorded image data are reproduced by means of a device for reproduction of image data, comprising the following:
reproduction means for reproducing image data of the object;
and
lens means with a plurality of lens elements which can image the light proceeding from the reproduction means,
wherein the reproduction means can reproduce the image data which have been recorded with a device for recording of image data.

21. The process as claimed in claim 20, wherein after recording and before reproduction of the image data they are processed, especially or digitally processed.

22. (canceled)

23. (canceled)

24. (canceled)

25. The device for recording and reproduction. of three-dimensional image data of an object as claimed in claim 14, wherein the device is a microscope, a video device or a photo device.
